(19) United States
(12) Patent Application Publication
(10) Pub. No.: US 2008/0206509 A1
(43) Pub. Date: Aug. 28, 2008

(54) Inlaid Decorative Panels

(76) Inventors: Richard Kent, Mequon, WI (US); Bennett Skaletski, Ripon, WI (US); Lance Schumacher, Ripon, WI (US); Andrew Derengowski, Princeton, WI (US)

Correspondence Address: BOYLE FREDRICKSON S.C., 840 North Plankinton Avenue, MILWAUKEE, WI, 53203, US

(21) Appl. No.: 11/934,163

(22) Filed: Nov. 2, 2007

Related U.S. Application Data
(60) Provisional application No. 60/856,207, filed on Nov. 2, 2006.

(51) Int. Cl. B44C 1/26; B32B 37/00

(52) U.S. Cl. 428/67; 156/250

(57) ABSTRACT

The present invention is a decorative panel formed with an inlay design created by forming a number of inlay openings within a substrate for the panel by laser cutting the openings in the substrate. The openings are formed in communication with a pocket that is formed in the substrate opposite the inlay openings, such that the inlay openings and the pocket extend completely through the substrate. The pocket enables a piece of a filler material to be positioned within a pocket to form an appropriate backing for the inlay members which are positioned in the inlay openings and securely attached to the filler material.

### CROSS-REFERENCE TO RELATED APPLICATION

This application claims priority from U.S. Provisional Application Ser. No. 60/856,207, filed on Nov. 2, 2006, which is expressly incorporated by reference herein in its entirety.

### FIELD OF THE INVENTION

The present invention relates to decorative panels, and more specifically to decorative panels including inlaid designs or patterns therein.

### BACKGROUND OF THE INVENTION

Decorative panels or other decorative surfaces are utilized in a wide variety of situations within both residential and commercial environments to provide a more aesthetically pleasing appearance to the environment. In a number of these environments, the decorative aspect of the panel is formed within the panel itself, such as by carving a decorative pattern directly into the panel. In other situations, the decorative aspect or piece of the panel is formed separately and secured to the exterior of the panel, such as by securing the decorative piece to the exterior of the panel by using a suitable adhesive or a mechanical fastener, such as a nail.

However, in certain situations it is desirable to preserve the relatively smooth or unbroken exterior surface of the panel, such as in flooring surfaces. Therefore, to provide decorative appearances to panels of this type, such as wood, the substrate material used in making the flooring is formed with an inlay disposed within the substrate that is positioned flush with the exposed or viewable surface of the substrate.

To form the inlays in the substrate, a number of different methods can be utilized. Normally, once a desired inlay design is selected, an opening corresponding to the shape of the inlay is cut completely through the substrate. The inlay is then positioned and secured within the opening formed in the substrate. After positioning the inlay within the opening, suitable veneers or laminates are positioned on each side of the substrate over the opening formed in the substrate material to assist in forming a seamless appearance to the substrate and to aid in holding the inlay materials within the substrate. Due to the fact that the substrate material is cut completely through to form the inlay openings, the veneer materials are required not only to hold the inlaid materials within the opening of the substrate but also to maintain the positioning of the inlaid materials with regard to one another in the substrate.

One significant shortcoming with decorative material constructions of this type is that the opening formed through the entire substrate creates significant limitations on the stability of the inlay materials positioned within the opening. Specifically, the veneer must be sufficiently thick to be able to securely hold the inlay materials within the openings formed in the substrate. However, this thickness can often detract from the appearance of the substrate along its side edges, making it unsuitable for uses other than flooring where only the top surface is exposed. Furthermore, because the inlay opening is cut through the entire substrate, the inlay material oftentimes must also be formed with a thickness identical to that of the substrate such that the inlay material and substrate are in alignment with one another. This requires that the inlay material often be cut not only to form the particular design, but also to have the same thickness as the board, which can affect the appearance of the inlay material, especially when the inlay material comprises different types of material from that of the substrate, or materials that are not easily cut or otherwise changed in size.

In those situations where the inlay material does not have the same thickness as the board, a filler material must be used to take up the remaining space in the opening to maintain the position of the inlay within the opening. However, the filler material must also be shaped to conform to the shape of the inlay opening formed in the board and can become compressed, or can otherwise shift or be altered in size, such that the inlay components are not maintained in position within the opening between the veneer layers.

Therefore, it is desirable to develop an inlay process and product formed from that process that forms a decorative surface on or in a substrate material in a manner that produces a material with an appearance that is suitable for uses other than flooring and that does not require the exact correspondence between the thickness of the inlay material and the substrate.

### SUMMARY OF THE INVENTION

Thus, according to a first aspect of the present invention, an inlay for a decorative panel is formed within a suitable substrate material by forming a pocket within a rear surface of the substrate material. Once the pocket is formed, an opening or openings corresponding to the design to be utilized for the inlay is then cut into the front surface through the remaining portion of the substrate opposite the pocket such that the inlay opening and the pocket communicate with one another and extend completely through the substrate. A filler material is then positioned within the pocket flush with the rear surface of the substrate material and is capable of providing a suitable backing for the inlay design pieces or components positioned within the inlay opening. The inlay pieces can then be formed and positioned within the inlay opening in the substrate and retained therein by use of a suitable mechanism, such as an adhesive that secures the inlay material within the opening to the filler material. A suitable veneer layer can then be positioned over the filler material and adjacent portions of the substrate in order to obscure the filler material and provide a seamless appearance to the non-inlaid surface of the decorative panel, if necessary.

According to another aspect of the present invention, the filler material can alternatively be positioned within the pocket prior to the inlay materials being inserted within the openings, such that the inlay materials can be secured directly to the filler material. This construction can then omit any covering veneer on the exposed surface, as the inlay material is securely held in position by the attachment to the filler material.

Numerous other aspects, features and advantages of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is an exploded isometric view of a decorative panel constructed with an inlay design according to the present invention; and

FIG. 2 is a block diagram illustrating the process for formation of the substrate of FIG. 1.

### DETAILED DESCRIPTION OF THE INVENTION

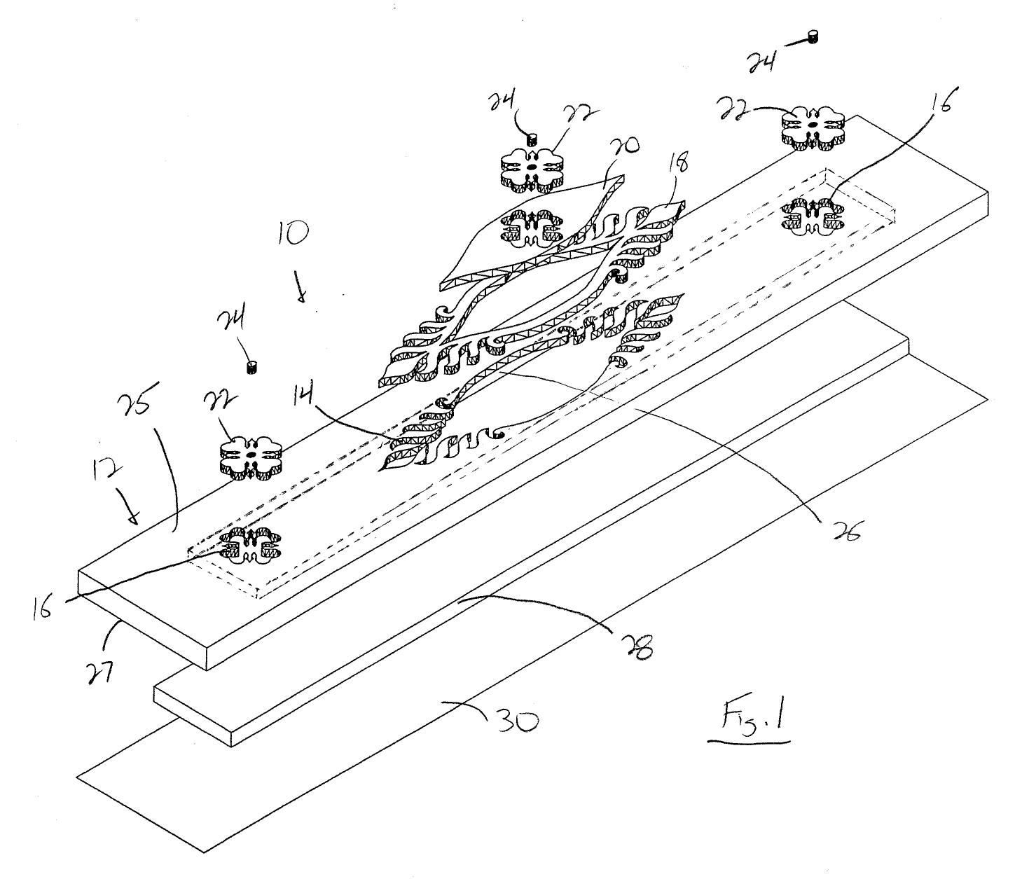

With reference now to the drawing figures in which like reference numerals designate like parts throughout the disclosure, a decorative panel constructed according to the present invention is indicated generally at 10 in FIG. 1. The panel 10 includes a substrate 12 formed of any suitable material, such as wood, stone, metal, or plastic, among others. The panel 10 can be designed for use in a flooring surface, as a step, a door, or as a cabinet panel, among other potential uses for the panel 10.

The substrate 12 for the panel 10 includes one or more inlay openings 14, 16 formed therein in which are positioned a number of inlay members 18-24, which may also have inlay openings formed in them. The substrate 12 may also have various other decorative features (not shown) formed on the substrate 12, such as beveled edges (not shown), glass panels (not shown) or carved designs (not shown), among others. The inlay openings 14, 16 extend partially through the substrate 12 from a front surface 25 of the substrate 12 and intersect a pocket 26 formed in the rear surface 27 of the substrate 12 opposite the inlay openings 14. The pocket 26 is formed to cover an area that is greater that the area of the inlay openings 14 and 16, such that the entire area of the inlay openings 14, 16 are in communication with the pocket 26.

A piece of filler material 28 is positioned within the pocket 26 to form a backing for the inlay openings 14, 16 within the substrate 12. The filler material 28 can be formed of any suitable material, such as a wood material, a plastic material, or other composite material, among others, and is secured within the pocket 26. The filler material 28 is secured within the pocket 26 such that the filler material 28 provides a backing directly beneath each of the inlay openings 14, 16, because as stated previously, the pocket 26 is formed to have dimensions that encompass each of the inlay openings 14, 16 formed in the substrate 12. The filler material 28 can be secured to the substrate 12 within the pocket 26 using any suitable means, such as an adhesive or a mechanical fastener, such as a nail or screw. In addition, the inlay members 18-24 can be secured directly to the filler material 28 when positioned within the openings 14, 16 using a suitable securing means, such as an adhesive or a mechanical fastener.

In addition, the substrate 12 also includes an optional decorative veneer layer 30 that can be secured to the rear surface 27 of the substrate 12 over the filler material 28 to enclose the filler material 28 and hide the placement of the filler material 28 within the substrate 12. The veneer 30 is preferably selected to match the appearance of the substrate 12 as closely as possible, thereby maintaining the desired appearance for the decorative panel 10.

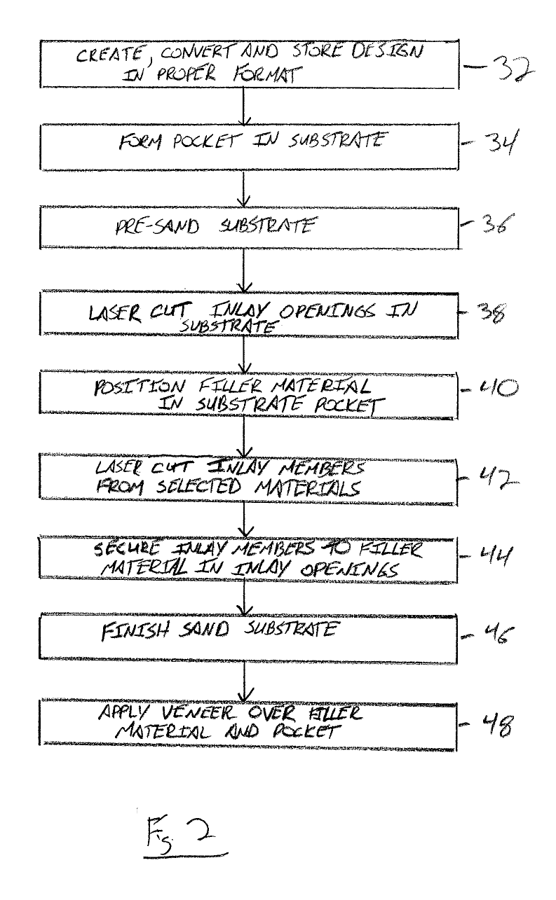

Looking now at FIG. 2, in the process for manufacturing the decorative panel 10, in block 32, the initial design for use as the inlay is created, converted and stored electronically. The design may be a hand or mechanically drawn rendering of a design desired to be used artistically in the manufacture of the decorative panel 10. If the design is initially created on paper, a scanner (not shown) is used to convert the image into a data stream (not shown) in a conventional manner. Once the paper image is converted, or if the design is initially created electronically, the image is then stored as suitable graphics file or document in a computerized storage medium, such as a personal computer (not shown) to which the scanner is connected. The design files can be retained in a proprietary fashion within the computerized storage medium to enable the design files to be accessed or utilized only by or for those individuals who created the designs and supplied them for use in forming decorative panels 10 utilizing those designs. To begin the process for forming the design in the decorative panel 10, the file corresponding to the desired design is converted into a suitable computer-aided design (“CAD”) format that can be utilized by a laser-cutting machine (not shown).

Either subsequently or concurrently with this step, in block 34, the substrate 12 has the pocket 26 formed therein. The size of the pocket 26 is determined by the size of the inlay design to be placed in the substrate 12, such that the pocket 26 is formed to be larger than the entire design. The pocket 26 is formed in the rear surface 27 of the substrate 12 by any suitable process, such as by routing the pocket 26 within the surface of the substrate 12. Also, the depth of the pocket 26 is selected such that the thickness of the inlay material and the depth of the pocket are equal to the overall thickness of the substrate 12.

In block 36, an additional and optional presanding step can be done on the front surface 25 of the substrate 12 to prepare the substrate 12 if necessary. After the pocket 26 has been formed, in block 38 the openings 14, 16 forming the selected design are laser cut into the front surface 25 or rear surface 27 of the substrate 12 opposite the pocket 26 to form the design therein. To minimize any discoloration of the substrate around the inlay openings 14, 16, the openings are preferably cut into the substrate 12 through the pocket 26. As stated previously, the depth of the pocket 26 determines the depth of the inlay openings 14, 16 formed by the laser cutting process within the substrate 12, which consequently defines the thickness of the various inlay members 18-24 to be positioned therein.

In block 40, after the inlay openings 14 and 16 have been formed via the laser cutting process in the substrate 12, the filler material 28 is positioned within the pocket 26 and secured therein in order to provide a suitable backing for the inlay members 18-24 to be positioned within the inlay openings 14 and 16. The filler material 28 is preferably adhered within the pocket 26 utilizing a suitable adhesive but can be attached with any suitable mechanism depending upon the particular material utilized to form the filler material 28. The filler material 28, when located in the pocket 26, completely fills the pocket 26, and is positioned flush with the rear surface 27 of the substrate 12.

After or concurrently with the placement of the filler material 28 within the pocket 26, in block 42 the various inlay members 18-24 are formed of the desired decorative materials by laser cutting the members 18-24 out of the desired materials. The decorative materials selected for the inlay members 18-24 can be woods, stones, metals, or plastics, among others. In addition, the various inlay members 18-24 can each be individually formed of a single material, or can be formed of various parts formed of different materials.

Once the inlay members 18-24 are formed as desired, in block 44 they are glued or otherwise secured in place within the inlay openings 14-16 against the filler material 28. After the inlay members 18-24 are secured in the openings 14, 16, in block 46 the decorative panel 10 is then finish sanded in order to provide the desired appearance to the panel 10. The final step in block 48 is the application of the veneer laminate 30 to the rear surface 27 of the substrate 12 over the filler material 28, which can be an optional step depending upon the particular use for which the decorative panel 10 is to be utilized.

Additionally, after the veneer layer 30 is applied to the substrate 12, other suitable modifications can be made to the various surfaces or edges of the panel 10 if necessary, such as beveling the edges of the panel 10 for particular uses of the panel 10, if these modifications have not already been done.

In this construction, due to the close tolerances formed by the laser cutting of the inlay members 18-24 and the inlay openings 14, 16, as well as the selection of the appropriate filler material 28, the finished decorative panel 10 does not have any significant issues concerning the expansion or contraction of the components of the panel 10, such that no lateral gaps form between the inlay members 18-24 and the inlay openings 14 and 16. Furthermore, the use of the filler material 28 as a backing for the inlay members 18-24 prevents the members 18-24 from being able to shift vertically within the panel 10.

Various alternatives are contemplated as being within the scope of the following claims particularly pointing out and distinctly claiming the subject matter regarded as the invention.

What is claimed is:

1. A decorative panel comprising:
a) a substrate material having a pocket formed in one side of the substrate, and one or more inlay openings formed in an opposite side of the substrate, wherein the inlay openings are in communication with the pocket;
b) a number of inlay members positioned within the inlay openings; and
c) a piece of filler material positioned within the pocket.

2. The decorative panel of claim 1 wherein the pocket has an area sufficient to encompass each of the one or more inlay openings.

3. The decorative panel of claim 1 wherein the inlay openings are formed to have a depth equal to a thickness of the inlay members.

4. The decorative panel of claim 1 wherein the filler material has a thickness equal to the depth of the pocket.

5. The decorative panel of claim 1 wherein the inlay members are secured directly to the filler material.

6. The decorative panel of claim 1 further comprising a veneer layer disposed on a rear surface of the substrate over the pocket and the filler material.

7. The decorative panel of claim 1 wherein the substrate and the filler material are formed of different materials.

8. The decorative panel of claim 1 wherein the inlay openings have a close tolerance with respect to the size of the inlay members.

9. A method of forming a decorative panel, the method comprising the steps of:
a) providing a substrate;
b) forming a pocket in one side of the substrate;
c) forming a number of inlay openings in the substrate;
d) forming a number of inlay members corresponding in shape to the inlay openings;
e) placing a filler material member within the pocket formed in the substrate; and
f) placing the inlay members within the inlay openings formed in the substrate.

10. The method of claim 9 wherein the step of forming the number of inlay openings comprises laser cutting the openings into the substrate.

11. The method of claim 10 wherein the step of forming the inlay openings comprises cutting the openings into the substrate within an interior of the pocket.

12. The method of claim 9 wherein the step of forming the inlay members comprises laser cutting the inlay members out of a desired material.

13. The method of claim 9 further comprising the step of placing a veneer layer on the substrate over the pocket and the filler member after placing the inlay members within the inlay openings.

14. The method of claim 9 further comprising the step of securing the inlay members to the filler material simultaneously with placing the inlay members within the inlay openings.

15. The method of claim 9 further comprising the step of sanding substrate and the inlay members after placing the inlay members within the inlay openings.
